(19) United States
(12) Patent Application Publication
(10) Pub. No.: US 2010/0152895 A1
(43) Pub. Date: Jun. 17, 2010

(54) Shock freezer and system for preparing samples for analysis using the same

(76) Inventor: Zhengshan Dai, Chapel Hill, NC (US)

Correspondence Address: SHLESINGER, ARKWRIGHT & GARVEY LLP, 5845 Richmond Highway, Suite 415, ALEXANDRIA, VA, 22303, US

(21) Appl. No.: 12/591,997

(22) Filed: Dec. 7, 2009

Related U.S. Application Data
(60) Provisional application No. 61/193,532, filed on Dec. 5, 2008.

(51) Int. Cl. B25J 9/00; F25D 3/10; F25D 25/00

(52) U.S. Cl. 700/245; 62/457.9; 62/62

(57) ABSTRACT

A shock freezer for rapidly freezing a sample preparatory to analysis, comprises an insulated closed container containing cryogenic fluid; a tubing disposed through the container having one end in contact with the cryogenic fluid and another end communicating outside the container, the another end for receiving a needle containing a sample to be shock frozen. The tubing has an inside diameter larger than an outside diameter of a capillary to be inserted therein to provide a space between an inside surface of the tubing and an outside surface of a capillary to be inserted therein to provide passageway for the cryogenic fluid to flow to the outside. An outlet communicates with an interior of the container. A relief valve is operably associated with the outlet, the relief valve being normally open to relieve pressure within the container, and the relief valve being closed when a capillary to be inserted containing a sample to be frozen is inserted into the tubing through the another end to allow pressure within the container to build up and force the cryogenic fluid to flow upwardly through the tubing through the space, thereby to freeze a sample in a capillary to be inserted.

### RELATED APPLICATION

This is a nonprovisional application claiming the priority benefit of provisional application Ser. No. 61/193,532, filed Dec. 5, 2008, hereby incorporated by reference.

### FIELD OF THE INVENTION

The present invention relates to a device, system and method for processing biological fluids which comprise cellular components by shock freezing.

### BACKGROUND OF THE INVENTION

When liquids have to be frozen in order to start a modification process, it is tricky to apply conventional cooling devices. A freeze rate of −180 deg C. in 2 sec. is required. After the freezing process, a heating process back to ambient or 37° C. is often desired and is part of the solution. One example of such a modification needed exist anywhere when cell material (whole blood, plant tissues, etc.) requires an opening of cells in order to analyze the complete content of cells. Today such processes consist of “crashing” cell material chemically and separating the various cell components by solid phase extraction, filtration and/or centrifugation. This is normally a very laborious process that takes time and is a big source for inconsistency in the final analytical results.

A method and device for processing a biological fluid for analyte determination by heat treatment is also known. For example, International Publication Number WO 2008/003451, discloses such a method and device.

### SUMMARY OF THE INVENTION

A shock freezer for rapidly freezing a sample preparatory to analysis, comprises an insulated closed container containing cryogenic fluid; a tubing disposed through the container having one end in contact with the cryogenic fluid and another end communicating outside the container, the another end for receiving a capillary containing a sample to be shock frozen. The tubing has an inside diameter larger than an outside diameter of a capillary to be inserted therein to provide a space between an inside surface of the tubing and an outside surface of a capillary to be inserted therein to provide passageway for the cryogenic fluid to flow to the outside. An outlet communicates with an interior of the container. A relief valve is operably associated with the outlet, the relief valve being normally open to relieve pressure within the container, and the relief valve being closed when a capillary to be inserted containing a sample to be frozen is inserted into the tubing through the other end to allow pressure within the container to build up and force the cryogenic fluid to flow upwardly through the tubing through the space, thereby to freeze a sample in a capillary to be inserted.

A method for shock freezing a sample, comprises providing a closed container containing a cryogenic fluid; providing a tubing extending into the container, the tubing communicating with the interior of the container and outside the container; providing a normally open relief valve to allow the cryogenic fluid to escape to the outside therethrough; inserting a capillary containing a sample to be frozen into the tubing; and closing the relief valve to force the cryogenic fluid to flow through the tubing, thereby freezing the sample as the cryogenic fluid passes through the tubing.

An automated system for preparing samples for analysis comprises a robot movable in three-dimensional space. The robot includes a syringe including a needle or capillary for drawing a sample from a vial into the needle. A shock freezer includes a closed container having an amount of cryogenic fluid and a tubing in contact with the fluid, the tubing including one end for receiving the capillary, and a relief valve communicating with the fluid that is closed when the capillary is inserted in the tubing to force the fluid to flow to the outside through the tubing. A heater is provided for thawing the capillary after being frozen. A receptacle is provided for receiving the sample after thawing for analysis.

### BRIEF DESCRIPTION OF THE DRAWINGS

FIG. 1 is a schematic cross-sectional view of an embodiment of a shock freezer incorporating the present invention.

FIG. 2 is a schematic front elevational view of a standard automated sample injector, incorporating the shock freezer of the present invention.

FIG. 3 is top plan view of FIG. 2.

FIG. 4 is a another view of FIG. 1, showing a syringe needle or capillary containing a sample to be frozen inserted into the shock freezer.

FIG. 5 is a schematic and enlarged cross-sectional view of a portion of FIG. 4, showing a pathway for the liquefied gas used for freezing a sample inside the capillary.

FIG. 6 is a schematic cross-sectional view of another embodiment of a shock freezer incorporating the present invention.

### DETAILED DESCRIPTION OF THE INVENTION

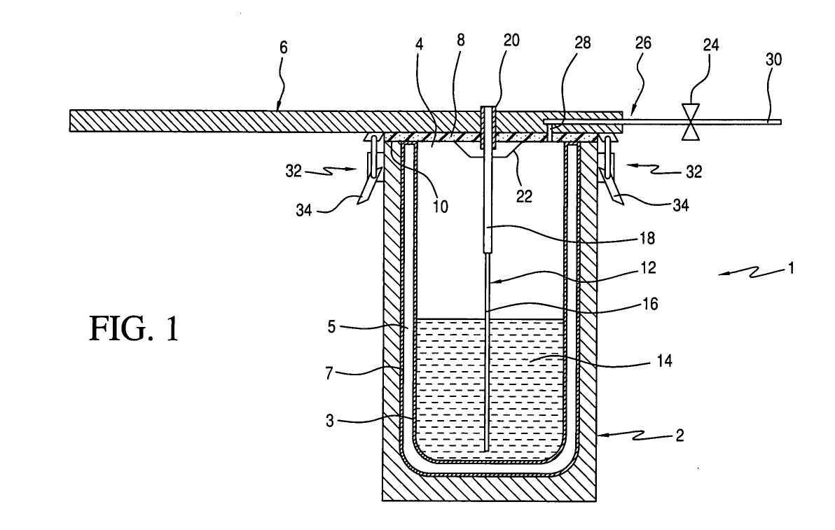

Referring to FIG. 1, a shock freezer 1 includes an insulated container 2 made of an inner glass wall 3 spaced from an outer glass wall 7 with partial vacuum 5 inbetween. The container 2 is commercially known as a Dewar flask. The container 2 has a top opening 4 closed off by a removable cover 6. A seal 8 provides a seal between the cover 6 and the top edge 10 of the container 2. The cover 6 is preferably made of polypropylene or other suitable material. The seal 8 is preferably made of EVA foam or other suitable material. The container is filled with an amount of cryogenic fluid or liquefied gas 14, such as liquefied CO₂ or N₂. Liquid nitrogen is preferably used, which has a boiling point of −196° C. at atmospheric pressure. The liquefied gas 14 provides the necessary heat exchange when it changes to the gas phase to shock freeze a sample. The seal 8 advantageously prevents excessive heat gain between the outside and the liquefied gas 14.

A tubing 12 extends through the cover 6 and into the interior of the container 2. The tubing 12 is preferably made in two parts; namely, a lower tubing 16, preferably made of plastic and an upper tubing 18, preferably made of stainless steel or other inert material. A sleeve 20, preferably made of stainless steel or suitable material, is attached to a flange 22, which is in turn attached to the seal 8 and the cover 6 with screws (not shown) or other standard means. The steel tubing 18 has an upper end attached to the sleeve 20 with adhesive or any standard means. The plastic tubing 16 is preferably attached to the lower end of the steel tubing 18 by friction fit or other standard means. The tubing 12 communicates with the liquefied gas 14 and to the outside of the container 2. The bottom end of the plastic tubing 16 is preferably close to or in contact with the bottom of the container 2 in order to use most of the liquefied gas during operation. Since the plastic tubing 16 is soft, preferably made of TEFLON (registered trademark) plastic material, the plastic tubing 16 will not scratch or break the inner glass wall 3 of the container.

A relief valve 24 opens or closes a passageway 26 into the interior of the container 2. The passageway 26 includes a tubing 28 extending through the seal 8 and partly into the cover 6. Another tubing 30 connects with the tubing 28 and extends horizontally through the thickness of the cover 6.

Clamps 32 of standard construction are operably attached to the cover 6 and the container 2 such that actuation of the levers 34 pushes the container 2 upwardly toward the cover 6, thereby compressing the seal 8 to seal the top edge of the container 2. Other standard means may be used to attach the cover 6 to the container 2 in a sealing manner.

The shock freezer 1 may be used manually to freeze a bio-fluid sample, such as whole blood, contained in a capillary or needle. After freezing for a predetermined amount of time, the frozen sample is then thawed in a heater for a predetermined amount of time. This prepares the biological fluid for analysis of any molecular compound contained in the fluid, the cell walls and cell contents.

The shock freezer 1 advantageously lends itself to the automation of sample preparation of whole blood, plant material or other biological substances, using a standard robotic platform, such as a computer driven sample injector under the model name COMBIPAL from Leap Technologies, Carrboro, N.C. 27510 or CTC Analytics AG, Industriestrasse 20, CH-4222 Zwingen, Switzerland. A product brochure of the COMBIPAL automated sampler, entitled GC/GC-MS Sample Injector Grows With Your Needs is hereby incorporated by reference.

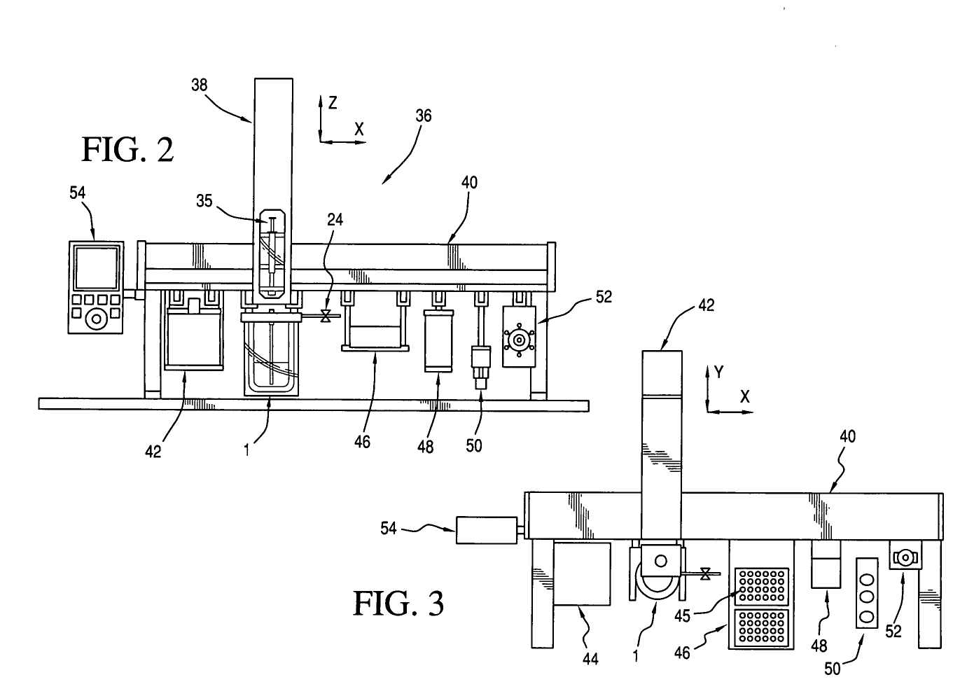

An automated system 36 for preparing samples for analysis, using the above-mentioned sample injector and incorporating the shock freezer 1, is schematically disclosed in FIGS. 2 and 3. The COMBIPAL sample injector is movable along the X, Y and Z axes, but other robotic platforms movable in three-dimensional space may be used with the shock freezer 1.

The automated system 36 includes a conventional syringe 35 carried by an arm 38 that moves in the vertical Z-axis and the horizontal X-axis along a support arm 40. The arm 38 is further movable along the horizontal Y-axis via arm 42 which is movable perpendicularly relative to the arm 40. The arm 40 supports a conventional agitator 44, the shock freezer 1, a conventional sample vial tray 46, a conventional needle heater 48, a conventional needle wash station 50 or a conventional needle changing station, and a conventional injection valve or port 52 where the prepared sample is injected for analysis by gas chromatography, mass spectrometry or other methods. A conventional handheld controller 54 is used to program the movements of the syringe 35 along the X, Y and Z-axes and operate the system.

In using the automated system 36 with the shock freezer 1, the raw samples are initially placed onto the tray 46, which may or may not include cooling. The samples may be in typical vials or in micro well plates covered with septa or plate covers that can be pierced by the typical syringe needle. The arm 38 picks up the first vial from a group of vials 45 on the tray 46 and moves it into the agitator 44 for a programmed amount of time to create a homogenized raw sample. The arm 38 then moves the vial back into its original vial holder on the tray 46.

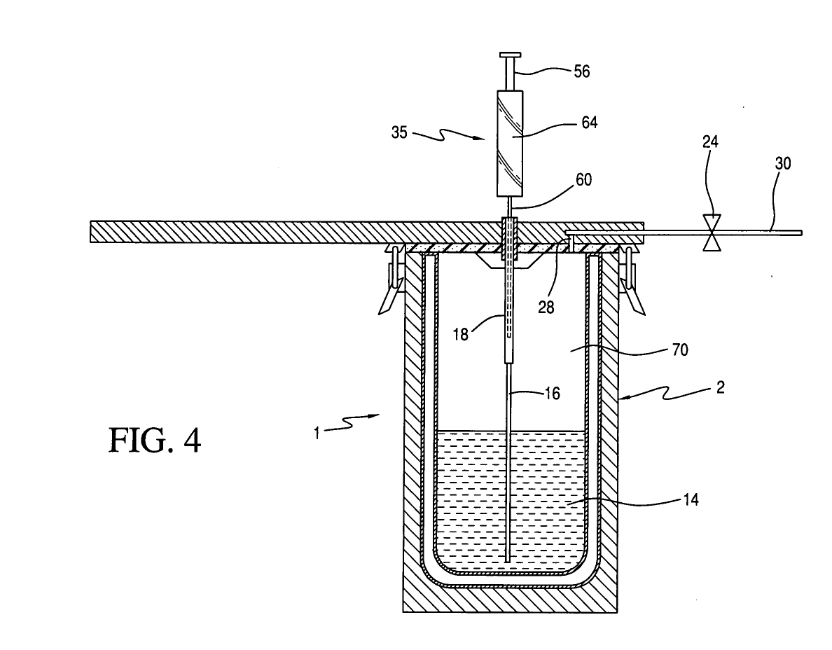

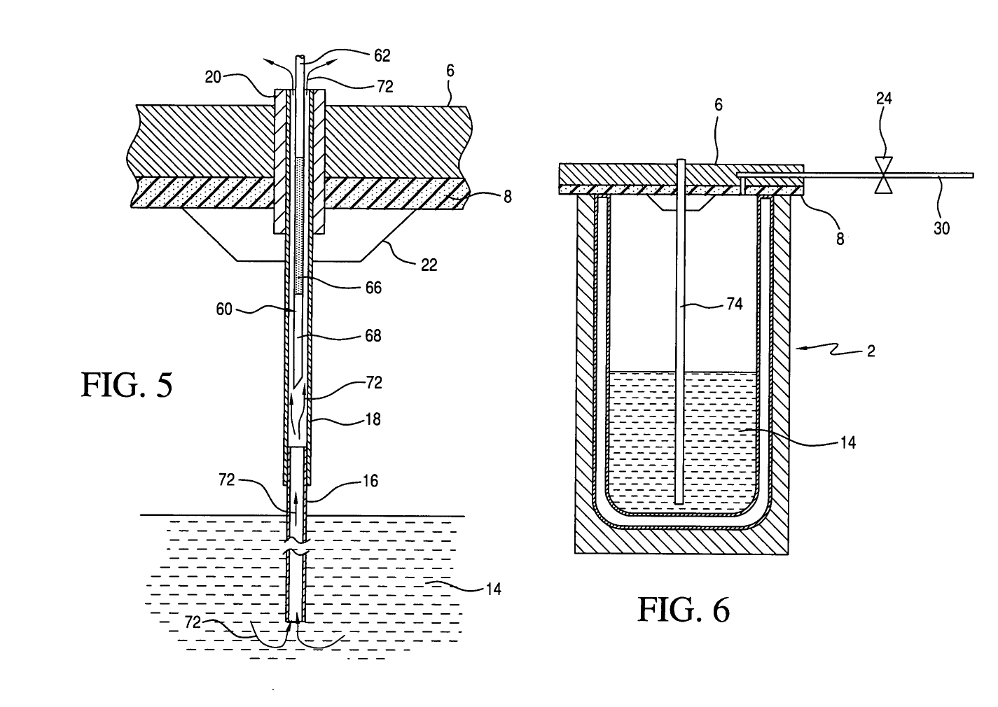

The arm 38 moves to the homogenized raw sample container. The syringe plunger 56 is moved up to create a vacuum 60 that pulls in a desired amount of air through the needle or capillary to create an upper air gap 62 (see FIG. 5). The syringe is lowered so that the syringe needle 60 pierces through the homogenized raw sample vial cover and lowered sufficiently that the needle tip is submersed into the liquid sample. The syringe plunger 56 is moved upwardly so that a vacuum created in the syringe barrel 64 causes the needle 60 to pull in a programmed amount of liquid sample. The syringe needle 60 is then retracted out of the sample container back into the ambient air. Once out of the sample container, the syringe plunger 56 moves up a programmed amount to pull air into the tip of the needle to create a lower air gap 68 (see FIG. 5). Referring to FIGS. 4 and 5, the arm 38, along with the syringe, moves to the shock freezer 1. The container 2 is provided with enough liquefied gas to allow for an unattended operation for about 24 hours. The needle 60 is inserted and lowered into the tubing 18. The normally open relief valve 24 is closed, allowing pressure to build up within the space 70 above the liquefied gas 14 within the container 2. The pressure build-up occurs due to the liquefied gas changing to the gaseous phase. The vapors that are normally allowed to escape through the tubing 28 and 30 via the normally open relief valve 24 are now allowed to accumulate in the headspace 70. The pressure build-up forces the liquefied gas at the bottom of the tubing 16 to flow upwardly through the tubing 18 and out to the ambient environment.

Referring to FIG. 5, the liquefied gas passes through the space between the outside diameter of the needle 60 and the inside diameter of the tubing 18, as generally indicated by the arrows 72. The inside diameter of the tubing 18 is sized to accommodate the outside diameter of the needle 60 and provide enough space between the needle 60 and the inside surface of the tubing 18 to allow for passage of the liquefied gas 14 in the liquid or gaseous phase. The liquefied gas turns into the gaseous phase as it passes through tubing 18, thereby freezing the sample 66. For a programmed amount of time the needle 60 with both air gaps 62 and 68 and the sample 66 are exposed to the liquefied gas vapor that provides the necessary rapid cooling. The sample 66 is cooled rapidly to the approximate temperature of the liquefied gas. The shock freezer 1 provides the preferred freeze rate of about −180° C. in 2 sec.

It will be noted from the above that by bringing a liquid sample contained in a capillary or piece of tubing and dipping it into liquid nitrogen or any other freezing agent (liquid or gas fumes), the content of the capillary will be cooled rapidly to the approximate temperature of the cooling agent.

The syringe 35 with the needle containing the now frozen sample 66 is retracted out of the tubing 18 and is moved over to the needle heater 48 that is at a set temperature. The relief valve 24 is opened to redirect the vapors through the outlet tubing 28 and 30. The syringe with the needle 60 is inserted through a cover into the needle heater 48 for an appropriate and programmed amount of time where a rapid heating of the needle 60 and frozen sample 66 to ambient temperature is achieved. The needle heater uses water kept preferably at about 37° C. for thawing the frozen sample. The heater 48 serves to bring the frozen sample back to about ambient temperature in 10 sec or less, or about 37° C. in 15 sec or less. The heating occurs at a rapid rate.

The syringe 35 with the needle 60 is retracted from the needle heater 48 with the thawed sample ready for analysis. The syringe 35 moves to a receiver such as the injection valve 52 where the needle 60 penetrates the valve needle guide and inlet and injects a programmed amount of the prepared sample for analysis by a chromatography, mass spectrometry or similar detection system. Alternatively the prepared sample can be injected into a clean sample container, such as a vial or micro plate on the tray 46, where it can be stored for further analysis. The needle 60 is either disposed off after each sample to prevent cross-contamination, or cleaned manually with appropriate agents or automatically in the wash station 50 with appropriate cleaning solutions. The wash station 50 may be replaced with a standard needle changing station also available with the COMBIPAL injector.

As can be seen above, the automated system 36 incorporating the shock freezer 1 provides the means for automating the process of preparing bio-fluids from a raw state (e.g. whole blood) to an ideal state for analysis of any molecular compound that is contained in the bio-fluid, including components contained in cell walls. Processing raw blood ready for analysis, using a typical manual method of chemical crashing, filtering and/or centrifuging, typically takes about 15 minutes. The system 36 typically takes about a minute, from start to injecting the prepared sample for analysis. The automated system 36 with the shock freezer 1 advantageously makes the process efficient and provides “fresh” samples since they are prepared seconds before analyzing them. The system provides a relatively short time, about a minute, of getting from the raw sample to the analytical result. Results are more consistently reproducible since there are no time lag variations once the cell content of the biological material is exposed, since it takes only seconds to expose the prepared sample to molecular separation and analysis by well-known chromatography, mass spectrometry or similar standard detection methods associated with the injection valve 52. The automated system 36 provides an efficient, relatively inexpensive, quick, hands-off automated work flow, utilizing conventional and widely accepted robotic (X-Y-Z) platforms.

Referring to FIG. 6, a one-piece tubing 74 made of TEFLON (registered trademark) plastic material may be used instead of the multi-component tubing 12.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

I claim:

1. A shock freezer for rapidly freezing a sample preparatory to analysis, comprising:
a) an insulated closed container containing cryogenic fluid;
b) a tubing disposed through said container having one end in contact with said cryogenic fluid and another end communicating outside said container, said another end for receiving a capillary containing a sample to be shock frozen, said tubing having an inside diameter larger than an outside diameter of a capillary to be inserted therein to provide a space between an inside surface of said tubing and an outside surface of a capillary to be inserted therein to provide passageway for said cryogenic fluid to flow to the outside;
c) an outlet communicating with an interior of said container; and
d) a relief valve operably associated with said outlet, said relief valve being normally open to relieve pressure within said container, said relief valve being closed when a capillary to be inserted containing a sample to be frozen is inserted into said tubing through said another end to allow pressure within said container to build up and force said cryogenic fluid upwardly through said tubing through said space, thereby to freeze a sample in a capillary to be inserted.

2. A shock freezer as in claim 1, wherein:
a) said container includes an outer glass wall spaced apart from an inner glass wall; and
b) a partial vacuum between said outer and inner glass walls.

3. A shock freezer as in claim 1, wherein said cryogenic fluid is liquid nitrogen.

4. A shock freezer as in claim 1, wherein said cryogenic fluid is carbon dioxide.

5. A shock freezer as in claim 1, wherein:
a) said container includes an opening; and
b) a cover in sealing closure to said opening.

6. A shock freezer as in claim 5, wherein said another end is disposed through said cover.

7. A shock freezer as in claim 5, wherein:
a) said opening including an outer edge; and
b) a sealer disposed between said cover and said outer edge.

8. A shock freezer as in claim 1, wherein said tubing is plastic, having one end immersed in said cryogenic fluid.

9. A shock freezer as in claim 1, wherein said tubing is an assembly comprising an upper portion made of metal and a lower portion made of plastic.

10. A shock freezer as in claim 9, wherein said metal is stainless steel.

11. A shock freezer as in claim 9, wherein said lower portion has a lower end disposed close to a bottom of said container.

12. A shock freezer as in claim 6, and further comprising a sleeve disposed through said cover.

13. A shock freezer as in claim 12, wherein:
a) said tubing is an assembly comprising a upper portion made of metal and a lower portion made of plastic; and
b) said upper portion is attached to said sleeve.

14. A shock freezer as in claim 1, wherein:
a) said outlet includes a horizontal tubing connected to a vertical tubing; and
b) said vertical tubing is in communication with an interior of said container.

15. A shock freezer as in claim 14, wherein:
a) said container includes an opening;
b) a cover in sealing closure to said opening; and
c) said horizontal tubing is disposed within said cover.

16. A method for shock freezing a sample, comprising:
a) providing a closed container containing a cryogenic fluid;
b) providing a tubing extending into said container, said tubing communicating with an interior of the container and outside the container;
c) providing a normally open relief valve to allow cryogenic fluid to escape to the outside therethrough;
d) inserting a capillary containing a sample to be frozen into said tubing; and
e) closing the relief valve to force the cryogenic fluid to flow through the tubing, thereby freezing the sample as the cryogenic fluid passes through the tubing.

17. A method as in claim 16, wherein said capillary is a needle.

18. An automated system for preparing samples for analysis, comprising:
a) a robot movable in three-dimensional space;
b) said robot including a syringe including a capillary for drawing a sample from a vial into said capillary;
c) a shock freezer including a closed container having an amount of cryogenic fluid and a tubing in contact with said fluid, said tubing including one end for receiving said capillary, and a relief valve communicating with said fluid that is closed when said capillary is inserted in said tubing to force said fluid to flow to the outside through said tubing;
d) a heater for thawing said capillary after being frozen; and
e) a receiver for receiving the sample after thawing for analysis.

19. An automated system as in claim 18, wherein:
a) said robot includes a first horizontal support corresponding to an X-axis;
b) a vertical arm movable along said horizontal support along said X-axis, said vertical arm corresponding to a Z-axis, said vertical arm being movable along said Z-axis;
c) said syringe is carried by said vertical arm; and
d) a second horizontal arm corresponding to a Y-axis;
said arm being movable along said X-axis and said Y-axis.

21. An automated system as in claim 18, and further comprising a needle changing station.

22. An automated system as in claim 18, and further comprising a needle wash station.
